(19) United States
(12) Patent Application Publication
(10) Pub. No.: US 2013/0205198 A1
(43) Pub. Date: Aug. 8, 2013

(54) WEB ANALYTIC TOOLS IN MESSAGING

(71) Applicant: PowerInbox, Petach Tikva (IL)

(72) Inventor: Ram Cohen, Tel Aviv (IL)

(73) Assignee: PowerInbox, Petach Tikva (IL)

(21) Appl. No.: 13/759,185

(22) Filed: Feb. 5, 2013

Related U.S. Application Data
(60) Provisional application No. 61/595,164, filed on Feb. 6, 2012.

(51) Int. Cl. G06F 17/22

(52) U.S. Cl. CPC G06F 17/2247
USPC 715/240

(57) ABSTRACT

Methods and configurations for e-mail analytics services that track recipient actions upon receiving an e-mail message. A senders list is maintained with identifiers and parameters of predefined e-mail senders. The senders list is accessible to an e-mail reader module installed in a recipient's device which receives e-mail sent from a sender on the senders list. The e-mail reader module inserts HTML code into the HTML page corresponding to the received message, for monitoring and reporting the recipient's actions regarding the received e-mail message to a web analytics server, which in turn reports analysis and statistics to a predefined e-mail analytics server for consolidation and reporting to senders on the senders list.

### CROSS REFERENCE TO RELATED APPLICATIONS

This application claims benefit of U.S. Provisional Patent Application Ser. No. 61/595,164, filed Feb. 6, 2012, the disclosure of which is hereby incorporated by reference and the priority of which is hereby claimed pursuant to 37 CFR 1.78(a) (4) and (5)(i).

### BACKGROUND

Web analytics tools are used to track user behavior while browsing the web, in order to assess and improve the effectiveness of marketing campaigns and conversion from the initial interaction stages up to completing a transaction.

There are commercial tools (such as Google Analytics, Yahoo Web Analytics) that let a website owner track user behavior by inserting HTML directives and including scripts in the website pages. These tools provide valuable insight to user interaction as he/she navigates the website, and they offer a variety of reporting and analysis tools.

Electronic messaging, such as e-mails, instant messaging, web based messaging services and SMS are widely used for communicating information between senders and recipients. Many commercial senders use messaging to send offers of their products, update their client base with news, and generally for ‘keeping in touch’ with their clients.

For those senders, it is critically important to know how many recipients have viewed a message and have interacted with it—for the same reasons it is important to know the recipient's behavior in the sender's website.

However, since almost all webmail providers and client messaging applications block elements such as scripts and similar executable objects that are included in a message it is not possible to use current website analytical tools within a message.

Furthermore, typical website analytics tools use HTTP cookies to identify a specific user between website visits. Cookies are accessible only when the user navigates within the domain of the sender and therefore are not accessible when the user (the recipient of an e-mail message) is in the webmail provider domain.

A common workaround for e-mails is to include within the message an HTML IMG tag with a URL that includes specific message or campaign identification. When the recipient's e-mail reader tries to fetch the image data, the server to which the URL points records those parameters in a database. This serves as a confirmation that the recipient has opened the message, but it is not a complete solution to the problem. First, most webmails and mail clients do not download images referenced in a message by default, but require the recipient to authorize such operation. This means that the information is incomplete—recipients reading the message without downloading images are not counted in compiling the statistics. Second, there is no way to know how much time the recipient spent reading the message—for example, did the reader spend time reading the contents, or just delete the message right away?

To track recipient behavior within the e-mail message, a typical practice is to track each click on a link by recording the operation on the server to which the link points. The link may in fact point to an intermediate server (provided perhaps by a mass e-mailing company) that records the recipient's click and then redirects the recipient's e-mail reader to the actual content residing on the sender's website.

Other recipient operations such as checking a checkbox or inserting text can't be tracked reliably since this would also require a script embedded in the message.

An additional problem with the above-mentioned solutions is that the statistics gathered by the ‘image open’ mechanism and the ‘intermediate link server’ mechanism are usually maintained and managed on a different platform from that of the web mail analytics platform. For example, the ‘image open’ is collected by a server in the mass e-mail sender service while the web mail statistics are collected by a tool such as Google Analytics.

This division of data makes it difficult to assess the effectiveness of messaging campaigns.

Therefore, it would be highly desirable to have a way by which message-related statistics can be reliably collected using the same tools employed in gathering and compiling website statistics. This goal is met by the present invention.

### SUMMARY

Embodiments of the present invention provide methods and configurations for monitoring, collecting, and reporting data relating to the actions of a recipient with respect to an e-mail message.

Recipient actions regarding an e-mail message include, but are not limited to:
opening the e-mail message;
moving away from the e-mail message, so that the recipient no longer sees the e-mail message, which can be done by actions including, but not limited to:
   deleting the e-mail message;
   viewing a different e-mail message;
   viewing other content than that of the e-mail message;
   navigating away from the e-mail message; and
   closing the e-mail reader tab/window;
clicking an element within the e-mail message, including, but not limited to:
   a hypertext link;
   a checkbox; and
   a button (e.g., a “radio” button);
entering text within an element in the e-mail message;
selecting an element within the e-mail message;
Forwarding or replying to the e-mail message;
Filing (or placing) the e-mail message in a message folder;
navigating from the e-mail message to a website related to the e-mail message sender;
opening a new e-mail reader window or tab to a website related to the e-mail message sender; and
performing a social activity action related to the e-mail message or to the e-mail message sender, including, but not limited to:
   performing a Facebook ‘Like’; and
   a Google+ +1 operation;

There are a variety of ways an e-mail recipient can access his or her e-mail and perform e-mail related actions, including those listed above. A recipient can use an Internet-based e-mail service (e.g., Google's “Gmail”) accessed via a local web browser installed in his or her computer or device; or a local e-mail client (e.g., Microsoft “Outlook”) installed in his or her computer. Additional ways of accessing e-mail include using a networked e-mail client (such as a web-based version of Microsoft “Outlook”) via a web browser; or using an e-mail client via a local Virtual Private Network (VPN) client application or a terminal emulator.

The term “e-mail reader” herein denotes any application capable of displaying received e-mail to a recipient and allowing the recipient to perform actions related to the e-mail as described above. The term “e-mail reader” includes, but is not limited to: Internet browsers, such as “Microsoft Internet Explorer”, “Mozilla Firefox”, “Apple Safari”, and the like; and e-mail client applications, such as “Microsoft Outlook”.

Different embodiments of the present invention cover e-mail readers where the e-mail message is read in an HTML window and where the e-mail reader has an “e-mail reader module” which includes custom executable code to perform actions as disclosed herein. The term “e-mail reader module” herein denotes a unit of executable code for execution within the context of an e-mail reader, including, but not limited to the following formats and combinations thereof:
executable code built into the e-mail reader;
external “extensions” of executable code;
external “add-ons” of executable code;
external “add-ins” of executable code; and
external “plug-ins” of executable code.

Some embodiments of the invention insert into an HTML document in the recipient's e-mail reader one or more HTML elements that enable the monitoring, collection, and reporting of data relating to the recipient's interaction with an e-mail message.

The HTML document in the recipient's e-mail reader in general includes more than just the received e-mail message. Other HTML elements include additional windows and controls (e.g., buttons, drop-down lists, scrolling regions, etc.) for manipulating e-mail messages and performing various actions on lists and folders of e-mail messages. In addition, in general the entire e-mail is not always contained in the HTML; for example, attachments to the e-mail message are not part of the HTML page.

According to various embodiments of the invention, HTML elements inserted into the HTML document in the e-mail reader include, but are not limited to:
a SCRIPT tag;
a script;
an IFRAME;
parameters that reference sender's specific information such as a sender ID within the analytics system, including, but not limited to:
   a campaign ID;
   the recipient's e-mail address or ID;
   a cookie of the website analytics server of the e-mail sender;
   the recipient's domain; and
   a sender-specific definition.

According to one related embodiment, the above HTML elements are inserted within the HTML code of the e-mail message; in another related embodiment, the HTML elements are inserted into other windows, panes, and frames of the HTML code in the e-mail reader. In some embodiments, the inserted HTML code is put into a new window, which is rendered invisible (such as by occupying zero area on the screen). According to another related embodiment the inserted element is an IFRAME element which is invisible to the recipient.

According to another related embodiment, the IFRAME contains a URL pointing to a website associated with the sender. In still another embodiment, the IFRAME contains a URL listed in the senders list. In yet another embodiment, the IFRAME contains a URL that includes parameters taken from the sender's list and/or the message contents, and/or are derived from the message contents.

According to additional embodiments, inserted HTML elements are inserted into the same HTML document as that of the message; in other embodiments, HTML elements are inserted into a different HTML document from that of the message.

In other embodiments of the present invention, insertion of HTML elements is done by a service via which the receiver is reading the messages (such as a webmail service). In further embodiments, insertion of HTML elements is done by an application on a device utilized directly or indirectly by the recipient. Such applications include, but are not limited to:
an Internet browser;
an e-mail client program;
an extension that adds functionality to an application; and
a standalone application, applet, or “app”.

Devices utilized by the recipient include, but are not limited to:
a personal computer/notebook computer/tablet computer/smart phone/workstation;
a proxy server; and
a gateway to the recipient's organization or private network.

In various embodiments of the invention, the e-mail message is searched for predetermined content in order to decide whether or not to monitor recipient interaction, collect data, and report to the server. In these embodiments, data sent to the server includes, but is not limited to:
parameters taken from a sender-specific definition;
a sender ID within the analytics system;
a campaign ID;
a cookie of the website analytics server of the e-mail sender;
the recipient's e-mail address or ID; and
the recipient domain.

Certain embodiments of the invention provide a senders list, which identifies e-mail senders for which data and statistics are to be collected. In a related embodiment, the senders list is stored in a server. In another related embodiment, the senders list is built into the executable code of the e-mail reader module.

In further related embodiments, the senders list contains parameters including, but not limited to:
the sender's e-mail address or domain;
which analytics server the sender is using; and
the sender's ID in the analytics system;
which recipient actions the sender is interested in and/or is allowed to collect;
which message content to check in order to decide whether to collect data, and/or what kind of data—in a non-limiting example, the sender might include certain text in the message that indicates which actions to track; in another non-limiting example, the presence of an interactive element in the content indicates that recipient actions related to that element should be tracked.

Therefore, according to an embodiment of the present invention, there is provided a method for operating an e-mail reader module to track actions of a recipient with respect to a received e-mail message contained in an HTML page displayed by the e-mail reader, wherein the received e-mail message is from a sender, the method including: responsively to the recipient opening the received e-mail message, retrieving, by the e-mail reader module, a record from a predefined senders list, wherein the record corresponds to the sender; inserting, by the e-mail reader module, an IFRAME element into the HTML page, wherein the IFRAME element points to a URL in a field of the record, so that an analytics server tracks an action of the recipient with respect to the e-mail message; and responsively to a destruction of an IFRAME corresponding to the IFRAME element, notifying, by the e-mail reader module, the analytics server that the recipient has moved away from the e-mail message.

In addition, according to another embodiment of the present invention, there is provided a method for operating an e-mail reader module to track actions of a recipient with respect to a received e-mail message contained in an HTML page displayed by the e-mail reader, wherein the received e-mail message is from a sender, the method including: responsively to the recipient opening the received e-mail message, retrieving, by the e-mail reader module, a record from a predefined senders list, wherein the record corresponds to the sender; and inserting, by the e-mail reader module, an HTML element into the HTML page wherein the HTML element is in a field of the record, so that an analytics server tracks an action of the recipient with respect to the e-mail message as displayed by the e-mail reader.

Moreover, according to still another embodiment of the present invention, there is provided a method for operating an e-mail reader module to track actions of a recipient with respect to a received e-mail message contained in an HTML page displayed by the e-mail reader, wherein the received e-mail message is from a sender, the method including: responsively to the recipient opening the received e-mail message, retrieving, by the e-mail reader module, a record from a predefined senders list, wherein the record corresponds to the sender; and inserting, by the e-mail reader module, an HTML code source into the HTML page wherein at least part of the HTML code source is in a field of the record, so that an analytics server tracks an action of the recipient with respect to the e-mail message as displayed by the e-mail reader.

### BRIEF DESCRIPTION OF THE DRAWINGS

The subject matter disclosed may best be understood by reference to the following detailed description when read with the accompanying drawings in which:

FIG. 1 conceptually illustrates an environment for performing analytics on an e-mail message, according to an embodiment of the present invention.

FIG. 2 conceptually illustrates various content of an e-mail message as handled by certain embodiments of the present invention.

FIG. 3 conceptually illustrates a senders list record according to an embodiment of the present invention.

FIG. 4 conceptually illustrates HTML code options for insertion into an HTML page according to certain embodiments of the present invention.

FIG. 5 is a flowchart of methods for tracking e-mail recipient actions according to certain embodiments of the present invention.

For simplicity and clarity of illustration, elements shown in the figures are not necessarily drawn to scale, and the dimensions of some elements may be exaggerated relative to other elements. In addition, reference numerals may be repeated among the figures to indicate corresponding or analogous elements.

### DETAILED DESCRIPTION

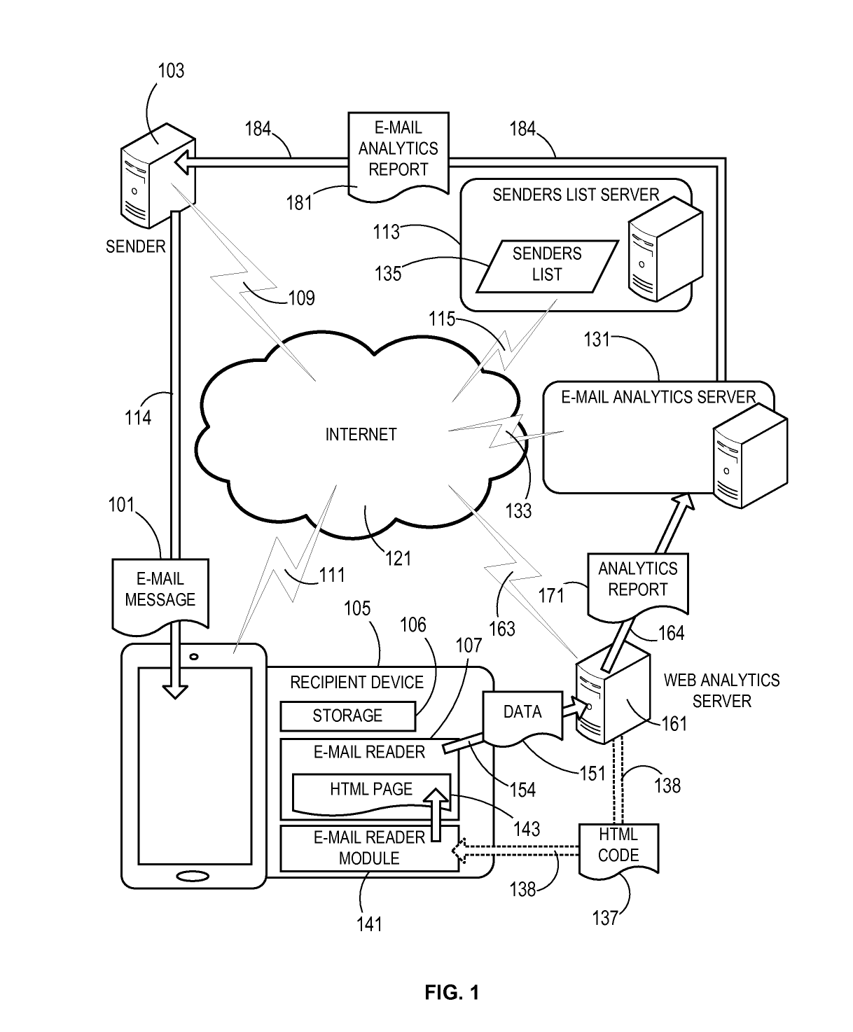

FIG. 1 conceptually illustrates an environment for performing analytics on an e-mail message 101 sent from a sender device 103 to a recipient device 105, according to an embodiment of the present invention. Sender device 103 is connected to Internet 121 via a connection 109, establishing a virtual connection 114 with recipient device 105. Sender device 103 can be any device capable of sending e-mail messages over Internet 121, non-limiting examples of which include: a server, and an e-mail service provider. In certain embodiments sender device 103 is operated by a mass-mailing service. Recipient device can be any user device capable of receiving e-mail messages over internet 121, non-limiting examples of which include: a workstation, a personal computer, a notebook computer, a tablet computer, and a smart phone. Recipient device 105 contains a non-transitory data storage 106, an e-mail reader application 107 containing an HTML page 143 corresponding at least in part to at least part of e-mail message 101, and an e-mail reader module 141 (as defined herein). At least part of e-mail message 101 is contained in HTML page 143 displayed by e-mail reader 107 of recipient device 105.

A web analytics server 161 is connected to Internet 121 via a connection 163, and is configured to provide tools that enable tracking of user behavior by inserting HTML directives and including scripts in HTML pages. Web analytic servers and methods provide valuable tools for analysis and gaining insight into interactive user behavior patterns when navigating across specific websites and web pages.

According to certain embodiments, an e-mail senders list 135 is maintained by a senders list server 113, which provides global access for senders list 135 over Internet 121 via a connection 115. Senders list 135 provides data and parameters about specific e-mail senders, and e-mail recipients who receive e-mail messages from the senders listed in senders list 135 may be monitored for their actions and behavior patterns when receiving and viewing those e-mail messages.

According to various embodiments of the present invention, an e-mail analytic server 131 is connected to Internet 121 via a connection 133. In some related embodiments, e-mail analytics server 131 is a logical device which is physically implemented within web analytics server 161. In these embodiments, In this particular embodiment, web analytics server performs all the analysis and reporting for the e-mail analytics. In other related embodiments, e-mail analytics server 131 is a physical device separate from web analytics server 161, and may provide additional services and/or functions related to data collection and reporting. In other embodiments, e-mail analytics server 131 provides global access for senders list 135.

Data collected about those actions and behavior patterns is sent to e-mail analytics server 131 for analysis and reporting to the senders.

According to additional embodiments of the invention, e-mail analytics server 131 (whether a logical or a physical device) provides analytics customized for the actions that a recipient of e-mail message 101 would perform on recipient device 105, including, but not limited to the actions previously presented in the foregoing “Summary” section of the present disclosure. Embodiments provide methods and configurations for monitoring, collecting, and reporting data relating to the actions of the recipient with respect to e-mail message 101 in the context of using recipient device 105.

In another embodiment of the invention, senders list 135 is embedded in the code of e-mail reader module 141, and in a related embodiment, senders list 135 is also accessible to e-mail analytics server 131.

According to certain embodiments, HTML code 137 is provided to e-mail reader module 141 for insertion into HTML page 143 (corresponding to e-mail message 101) within e-mail reader 107. The inserted HTML code enables tracking recipient actions, as disclosed herein. In an embodiment of the invention, HTML code 137 provides a URL or an IP (Internet Protocol) Address of a page in the sender's website that provides code for tracking in web analytics server 161 to e-mail reader module 141, as indicated by a reference 138. In another embodiment of the invention, the URL or IP Address is to e-mail analytics server 131 for providing code for tracking in web analytics server 161.

HTML code 137, when inserted into e-mail message 101 HTML page 143, provides tracking data 151 to web analytics server 161 via a virtual connection 154, in the same manner as a website page with an embedded HTML tracking script would provide to web analytics server 161. In turn, web analytics server 161 sends an analytics report 171 to e-mail analytics server 131 via a virtual connection 164. To complete the process, e-mail analytics server 131 sends an e-mail analytics report 181 to sender 103 via a virtual connection 184. In a related embodiment, e-mail analytics report 181 is based on analytics report 171 but is further processed for sender 103. According to various embodiments, e-mail message 101 is sent to multiple recipients, and e-mail analytics report 181 provides sender 103 with analysis and statistical summaries of the actions of multiple recipients regarding receipt of e-mail message 101.

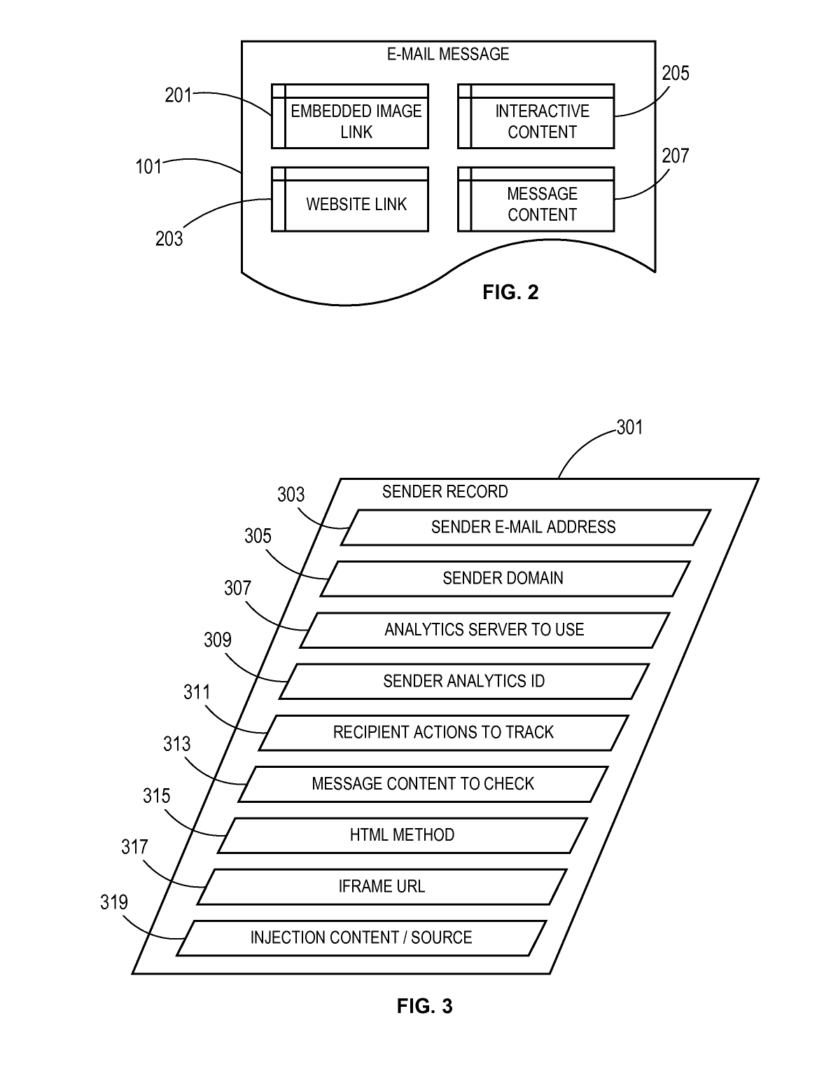

FIG. 2 conceptually illustrates various content of e-mail message 101 as handled by certain embodiments of the present invention. In these embodiments, e-mail message 101 contains an embedded image link 201, a website link 203, an interactive component element 205, and a message content 207. In related embodiments interactive component element 205 can be a button, a drop-down list, a text entry box, or other such control.

FIG. 3 conceptually illustrates a senders list record 301 according to an embodiment of the present invention. Senders list 135 (FIG. 1) contains one or more records such as record 301, each of which provides identification, parameters, and other information related to a particular e-mail message sender. In various embodiments, senders list record 301 contains fields such as:
a field 303 containing the sender's e-mail address;
a field 305 containing the sender's web domain;
a field 307 identifying the web analytics server to use (e.g., web analytics server 161);
a field 309 with the sender's ID in the web analytics system (e.g., the sender's ID in web analytics server 161);
a field 311 with the recipient's actions to track (as enumerated previously in the present disclosure, in the “Summary” section);
a field 313 with the e-mail message content to check regarding which specific recipient actions need tracking, and which corresponding e-mail analytics need to be collected;
a field 315 with the HTML method to use—in one related embodiment, an IFRAME is inserted into HTML page 143 (FIG. 1); in another related embodiment, HTML injection is used to insert injected content into HTML page 143;
a field 317 with an IFRAME URL, if an IFRAME is being used; and
a field 319 with HTML injection content or HTML injection content source, if HTML injection is being used.

FIG. 4 conceptually illustrates HTML code 137 options for insertion into HTML page 143 (FIG. 1) according to certain embodiments of the present invention. In one embodiment an IFRAME code 401 is inserted; in another embodiment, an HTML code or an HTML code source 403 is injected.

In one embodiment of the present invention, an IFrame is added, as illustrated in FIG. 4 with IFRAME code 401. This enables sender 103 to track recipient actions and events such as ‘message open’ as well as ‘message closed’ (when the IFrame is destroyed). In addition, this can potentially identify the recipient (i.e., recipient device 105) if that recipient has previously visited a website of sender 103, by means of a cookie from the website. In this case, if the e-mail actions and events of recipient device 105 are reported to the same web analytics server used by the website of sender 103, it is possible to generate reports combining user interaction within the website with the open/close events in e-mail message 101 by recipient device 105. However, common security practice typically does not allow the IFrame to collect data for events that occur outside of the IFrame (i.e. in e-mail 101) so it may not be possible to collect actions such as ‘moved to trash’, etc.)

In another embodiment of the present invention, HTML elements (scripts) are added to HTML page 143. In a non-limiting example, HTML page 143 contains e-mail message 101 within a webmail page, such as Gmail. The HTML script monitors and reports on all recipient activities within the entire webmail page, including not only e-mail message 101, but also all the surrounding elements, such as the ‘Delete’ button, by attaching to the various HTML elements on HTML page 143. However, one restriction to this is that recipient device 105 is identified by the recipient's e-mail address, which is not easily paired with the information of the same recipient in a website of sender 103, since the website information is tracked using a cookie which is not accessible to scripts running within HTMP page 143 (the webmail page).

In a non-limiting example of IFRAME use, the following HTML code is inserted into HTML page 143:

<IFrame src=‘//stats.acme.com/mail-tracking/trackpage.php’/>

In this non-limiting example, the element adds an IFRAME to HTML page 143 with the following contents from the URL ‘stats.acme.com/mail-tracking/trackpage.php’.

```
<html>
    <head>
        <script type=“text/javascript”
            src=“https://ssl.google-analytics.com/ga.js” />
            <script type=“text/javascript”>
                var _gaq = _gaq || [ ];
                gaq.push([‘_setAccount’,‘UA-11111111-1’]);
                gaq.push([‘_trackPageview’]);
        </script>
    </head>
    <body>
    </body>
</html>
```

The HTML in the IFrame is executed (as well as any scripts) and those scripts enable tracking of recipient actions and events.

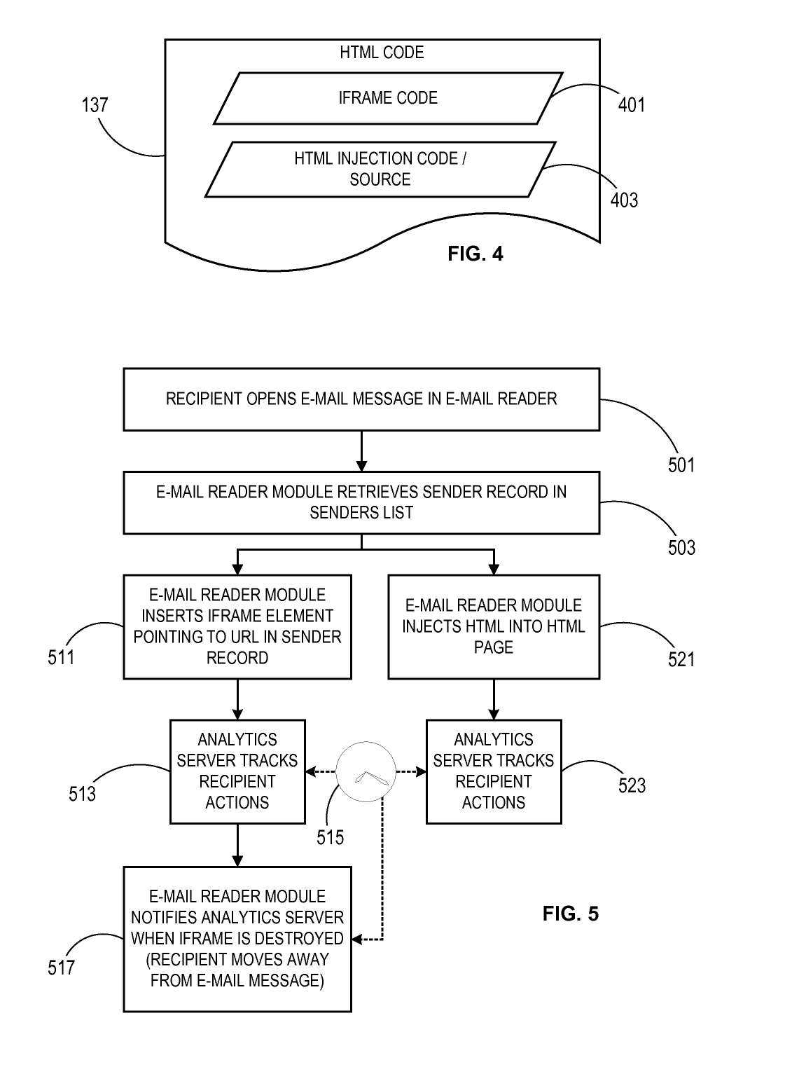

FIG. 5 is a flowchart of methods for tracking e-mail recipient actions according to certain embodiments of the present invention, detailed as follows, with reference to FIG. 1, FIG. 3, and FIG. 4: In a step 501, the recipient opens e-mail message 101 in e-mail reader 107. In a step 503 e-mail reader module 141 retrieves record 301 corresponding to sender 103, from senders list 135.

According to one embodiment of the invention, in a step 511 e-mail reader module 141 inserts IFRAME element 401 into HTML page 143, which points to IFRAME URL 317 of sender 103 record 301, so that in a step 513 analytics server 161 tracks the actions of the recipient with respect to e-mail message 101 in e-mail reader 107. A clock 515 records the elapsed times of each successive action for further analysis. Finally, when the recipient moves away from e-mail message 101 (by performing any of several actions as disclosed above), the IFRAME is destroyed, and in a step 517 e-mail reader module 141 notifies analytics server 161 accordingly. Clock 515 records the time of this event to obtain the total time that e-mail message 101 was in view on e-mail reader 107. In an embodiment, clock 515 is provided by e-mail reader module 141 using hardware of recipient device 105. In additional embodiments of the invention, e-mail reader module 141 also reports recipient actions in the webmail (including deleting, forwarding, etc., as disclosed above) to analytics server 161. Reporting to analytics server 161 typically involves sending an event to the IFrame document or changing the URL of the IFrame source by providing a parameter to the URL or a hash tag parameter.

According to another embodiment of the invention, in a step 521 e-mail reader module 141 injects HTML code or code source 403 into HTML page 143, so that in a step 523 analytics server 161 tracks the actions of the recipient with respect to e-mail message 101 in e-mail reader 107, as disclosed above. Clock 515 records the elapsed times of each successive action for further analysis.

Additional embodiments of the present invention provide an application (or “applet” or “app”) for an e-mail reader module, which includes executable code stored in non-transitory storage 106 of recipient device 105, which code, when executed by recipient device 105, performs a method according to an embodiment of the present invention, as disclosed herein.

What is claimed is:

1. A method for operating an e-mail reader module to track actions of a recipient with respect to a received e-mail message contained in an HTML page displayed by the e-mail reader, wherein the received e-mail message is from a sender, the method comprising:
responsively to the recipient opening the received e-mail message, retrieving, by the e-mail reader module, a record from a predefined senders list, wherein the record corresponds to the sender;
inserting, by the e-mail reader module, an IFRAME element into the HTML page, wherein the IFRAME element points to a URL in a field of the record, so that an analytics server tracks an action of the recipient with respect to the e-mail message; and
responsively to a destruction of an IFRAME corresponding to the IFRAME element, notifying, by the e-mail reader module, the analytics server that the recipient has moved away from the e-mail message.

2. The method of claim 1, wherein the action of the recipient is selected from a group consisting of:
opening the e-mail message;
moving away from the e-mail message, so that the recipient no longer sees the e-mail message;
clicking an element within the e-mail message;
entering text within an element in the e-mail message;
selecting an element within the e-mail message;
navigating from the e-mail message to a website related to the e-mail message sender;
opening a new e-mail reader window or tab to a website related to the e-mail message sender;
performing a social activity action related to the e-mail message; and
performing a social activity action related to the e-mail message sender.

3. A method for operating an e-mail reader module to track actions of a recipient with respect to a received e-mail message contained in an HTML page displayed by the e-mail reader, wherein the received e-mail message is from a sender, the method comprising:
responsively to the recipient opening the received e-mail message, retrieving, by the e-mail reader module, a record from a predefined senders list, wherein the record corresponds to the sender; and
inserting, by the e-mail reader module, an HTML element into the HTML page wherein the HTML element is in a field of the record, so that an analytics server tracks an action of the recipient with respect to the e-mail message as displayed by the e-mail reader.

4. The method of claim 3, wherein the HTML element is selected from a group consisting of:
a SCRIPT tag;
a script;
an IFRAME;
a campaign ID;
an e-mail address; and
a domain.

5. A method for operating an e-mail reader module to track actions of a recipient with respect to a received e-mail message contained in an HTML page displayed by the e-mail reader, wherein the received e-mail message is from a sender, the method comprising:
responsively to the recipient opening the received e-mail message, retrieving, by the e-mail reader module, a record from a predefined senders list, wherein the record corresponds to the sender; and
inserting, by the e-mail reader module, an HTML code source into the HTML page wherein at least part of the HTML code source is in a field of the record, so that an analytics server tracks an action of the recipient with respect to the e-mail message as displayed by the e-mail reader.
